(19) United States
(12) Patent Application Publication
(10) Pub. No.: US 2024/0263358 A1
(43) Pub. Date: Aug. 8, 2024

(54) TEXTILE ELEMENTARY MONOFILAMENT CONSISTING OF A POLYESTER

(71) Applicants: COMPAGNIE GENERALE DES ETABLISSEMENTS MICHELIN, Clermont-Ferrand (FR); Centre National De La Recherche Scientifique (CNRS), Paris (FR); INSTITUT NATIONAL DES SCIENCES APPLIQUÉES DE LYON, Villeurbanne (FR); Université Claude Bernard Lyon 1, Villeurbanne (FR); Université Jean Monnet, Saint-Etienne (FR)

(72) Inventors: MARC SUTTER, Clermont-Ferrand (FR); CHRISTOPHE LE CLERC, Clermont-Ferrand (FR); MÉLISSA POLONI, VILLEURBANNE (FR); MARION COLELLA, VILLEURBANNE (FR); JULIEN BERNARD, VILLEURBANNE (FR); ALAIN ROUSSEAU, VILLEURBANNE (FR)

(21) Appl. No.: 18/560,979

(22) PCT Filed: May 9, 2022
(86) PCT No.: PCT/FR2022/050879

§ 371 Date: Nov. 15, 2023

(30) Foreign Application Priority Data
May 18, 2021 (FR) FR2105152

(51) Int. Cl. D01F 6/84; C08G 63/672; C08G 63/78; D01D 5/08

(52) U.S. Cl. CPC D01F 6/84; C08G 63/672; C08G 63/78; D01D 5/08; D10B 2331/04; D10B 2401/063

(57) ABSTRACT

The invention relates to a textile elementary monofilament consisting of a polyester, said textile elementary monofilament having a melting point Tm of greater than or equal to 240° C., a tenacity of greater than or equal to 2.5 cN/tex and an elongation at break of greater than or equal to 10%, and also to a process for producing such a monofilament.

### TECHNICAL FIELD OF THE INVENTION

The present invention relates to the field of polyester textile yarns and to processes for manufacturing such polyester yarns.

### PRIOR ART

Polyesters have many applications in the industrial and textile fields, in particular for the production of fibres for clothing. Their variety of applications is such that huge volumes are produced each year. It is thus of interest to synthesize polyesters from monomers derived from renewable resources, and which have technical characteristics that allow them to substitute for petroleum-based polyesters such as polyethylene terephthalate (PET).

Extensive research has been conducted into producing polyesters from furandicarboxylate monomers. These monomers may be produced from natural resources such as sugars. The synthesis of the polyester typically comprises an esterification step and a polycondensation step, optionally followed by crystallization and solid-state post-condensation steps so as to adjust the properties of the polyester. The structure, and thus the characteristics, of the polyester obtained depend on how these various steps are performed.

For example, patent application WO 2015/137805 describes a polyethylene furanoate (PEF) type polyester with a low content of diethylene glycol units and the process for synthesizing same. The synthesis in particular comprises esterification, in the presence of a compound which suppresses the formation of diethylene glycol, and polycondensation steps. The presence of this suppressor compound allows a very low amount of diethylene glycol units to be obtained in the PEF and thus improves the melting point and degree of crystallinity of the polyesters obtained.

Patent application WO 2013/055860 describes a polyester comprising dicarboxylic acid units and glycol units whose glass transition temperature is relatively stable over a wide range of polyester compositions. Said patent application mentions many possible uses for such a polyester, notably as a fibre, but does not teach how to give said fibres mechanical properties of interest.

Continuing its research, the Applicant discovered a textile elementary monofilament having a high melting point and high tenacity, particularly suitable for use in the manufacture of fabrics. This textile elementary monofilament may be obtained via a combination of steps and of particular operating conditions which constitute an improvement on the processes known in the prior art.

### DETAILED DESCRIPTION OF THE INVENTION

The invention relates to at least one of the following embodiments:
1) Textile elementary monofilament consisting of a polyester of formula (I)

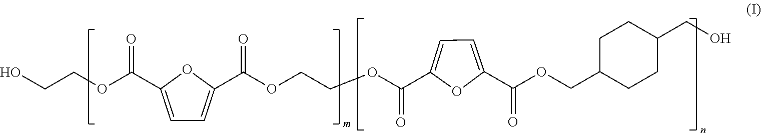

in which m represents the total number of ethylene glycol furandicarboxylate units and n the total number of cyclohexanedimethanol furandicarboxylate units with n non-zero, m+n≥25, the mole ratio between the ethylene glycol units denoted EG and the cyclohexanedimethanol units denoted CHDM ranging from 0/100 mol/mol to 20/80 mol/mol, said textile elementary monofilament having a melting point Tm of greater than or equal to 240° C., a tenacity of greater than or equal to 2.5 cN/tex and an elongation at break of greater than or equal to 10%.
2) Textile elementary monofilament according to the preceding embodiment, in which the furan ring represents at least 25% by weight of the polyester.
3) Textile elementary monofilament according to either of the preceding embodiments, in which the polyester has a weight-average molar mass of greater than 45 000 g/mol in PMMA equivalent, preferentially greater than 55 000 g/mol.
4) Textile elementary monofilament according to any one of the preceding embodiments, in which the polyester has an intrinsic viscosity of greater than 0.7 dL/g, very preferentially greater than 0.8 dL/g.
5) Textile elementary monofilament according to any one of the preceding embodiments, in which the polyester has a dispersity, noted D and representing the ratio of the weight-average molar mass to the number-average molar mass (Ð=Mw/Mn), of less than 2.5, preferably less than 2.0.
6) Textile elementary monofilament according to any one of the preceding embodiments, in which the mole ratio between the ethylene glycol units and the cyclohexanedimethanol units ranges from 4/96 mol/mol to 15/85 mol/mol.
7) Textile elementary monofilament according to any one of the preceding embodiments, having a tenacity of greater than or equal to 3 cN/tex and an elongation at break of greater than or equal to 15%.
8) Textile elementary monofilament according to any one of the preceding embodiments, having a shrinkage of less than 14%, preferentially less than 12%.
9) Textile elementary monofilament according to any one of the preceding embodiments, coated with one or more layers of a coating based on a non-metallic adhesive composition.
10) Fabric comprising at least one textile elementary monofilament according to any one of the preceding embodiments.
11) Process for preparing a textile elementary monofilament consisting of a polyester, comprising successively:
   A step of transesterification of a composition comprising a compound of furandicarboxylate type, denoted RFC, of general formula (II)

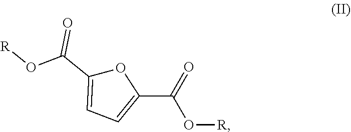

in which R represents an alkyl group comprising from 1 to 3 carbon atoms or a hydrogen atom, the composition also comprising at least one glycol compound chosen from 1,4-cyclohexanedimethanol and the mixture of 1,4-cyclohexanedimethanol and ethylene glycol, this transesterification step being performed at a temperature increasing with a ramp of at least 1° C./min in the range from 180° C. to 280° C., with a glycol compound/RFC mole ratio ranging from 1.1 to 2, preferentially ranging from 1.1 to 1.2, in the presence of a Lewis acid catalyst;
A melt polycondensation step performed at a temperature of greater than or equal to 260° C. and a pressure of less than 100 mbar so as to obtain a polyester, the 1,4-cyclohexanedimethanol being present in the composition of the transesterification step in a content such that the mole ratio between the ethylene glycol units and the cyclohexanedimethanol units in the polyester on conclusion of the polycondensation step ranges from 0/100 mol/mol to 20/80 mol/mol;
A step of spinning the polyester so as to obtain a textile elementary monofilament.
12) Process according to the preceding embodiment, in which, in the compound of general formula (II), R represents an alkyl group comprising from 1 to 2 carbon atoms.
13) Process according to either of embodiments 11 and 12, in which the transesterification step is performed for a time ranging from 1 to 5 h, preferentially from 1 to 3 h.
14) Process according to any one of embodiments 11 to 13, in which, in the transesterification step, the temperature rises continuously in the range from 180° C. to 280° C. at a ramp of less than or equal to +5° C./min.
15) Process according to any one of embodiments 11 to 14, in which the catalyst used in the transesterification step is chosen from hafnium acetylacetonate, zirconium acetylacetonate, titanium tetraisopropoxide and titanium tetrabutoxide, and preferentially is titanium tetrabutoxide.
16) Process according to any one of embodiments 11 to 15, in which the transesterification step is performed at a pressure ranging from 1.5 to 8 bar, preferentially from 1500 to 8000 mbar.
17) Process according to any one of embodiments 11 to 16, in which the polycondensation step is performed at a temperature of greater than or equal to 270° C., preferably greater than or equal to 280° C.
18) Process according to any one of embodiments 11 to 17, in which the polycondensation step is performed at a pressure of less than 50 mbar.
19) Process according to any one of embodiments 11 to 18, in which, following the polycondensation step, a forming step is performed, in which the polyester is rapidly cooled by placing in contact with water, then cut into granules, then dried at a temperature ranging from 80° C. to 100° C. at a pressure less than or equal to atmospheric pressure under an inert atmosphere.
20) Process according to the preceding embodiment, in which, following the forming step, a crystallization step is performed, when the composition used in the transesterification step does not comprise ethylene glycol, at a temperature ranging from 120° C. to the melting point of the polyester, preferentially ranging from 130° C. to 150° C., and for a time ranging from 15 min to 2 h, and performed when the composition used in the transesterification step comprises ethylene glycol, at a temperature ranging from 220° C. to the melting point of the polyester, preferentially ranging from 220° C. to 230° C. and for a time ranging from 10 min to 2 h, followed by a solid-phase post-condensation step performed at a temperature increasing in the range from 200° C. to 260° C. and for a time ranging from 1 to 60 h.
21) Process according to the preceding embodiment, in which the solid-phase post-condensation step is performed at a temperature increasing in the range from 210° C. to 260° C., preferentially in the range from 220° C. to 250° C., for a time ranging from 24 h to 72 h, preferentially from 10 h to 60 h, under a flow of inert gas.
22) Process according to the preceding embodiment, in which the temperature of the solid-phase post-condensation step is increased in steps within a range from 2 to 10° C.
23) Process according to any one of embodiments 11 to 22, in which the spinning step, performed as the last step of said process, is performed at a temperature above the melting point of the polyester, adjusted so that the pressure at the die inlet is between 3.3 and 10.0 MPa, followed by a drawing step on a series of drawing cups, each drawing cup being at a temperature ranging from 40° C. to 160° C., the draw ratio ranging from 3 to 6.
24) Process according to the preceding embodiment, in which the spinning and drawing phase is performed continuously without intermediate winding.
25) Process according to either of embodiments 23 and 24, in which the first drawing cups are at a temperature of 90° C. to 160° C., preferentially from 105° C. to 145° C., the temperature of the last drawing cup ranging from 40 to 80° C. so as to perform a relaxation step.
26) Process according to any one of embodiments 23 to 25, in which the final winding speed is between 500 and 5000 m/min, preferentially between 1000 and 3000 m/min.

### Definitions

The compounds comprising carbon mentioned in the description may be of fossil or biobased origin. In the latter case, they may be partially or completely derived from biomass or may be obtained from renewable starting materials derived from biomass. Polymers, plasticizers, fillers, etc. are notably concerned.

Any range of values denoted by the expression “between a and b” represents the field of values ranging from more than a to less than b (that is to say limits a and b excluded) whereas any range of values denoted by the expression “from a to b” means the field of values ranging from a up to b (that is to say including the strict limits a and b).

Unless explicitly stated otherwise, the pressures are expressed in absolute values.

### Polyester According to the Invention

The invention relates to a textile elementary monofilament consisting of a polyester of formula (I)

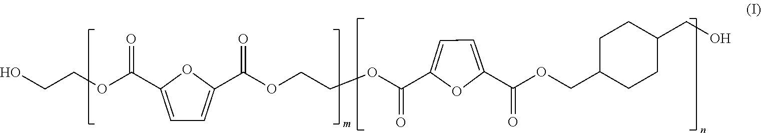

derived from the condensation of the monomers ethylene glycol (noted EG) and cyclohexanedimethanol (noted CHDM), shown in figure (II)

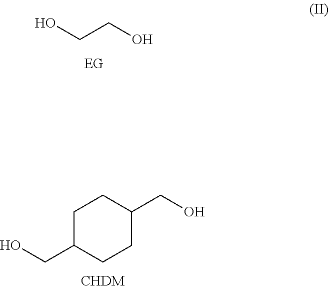

in which m represents the total number of ethylene glycol furandicarboxylate units, and n the total number of cyclohexanedimethanol furandicarboxylate units, with n non-zero and m+n≥25, preferentially m+n≥35, the mole ratio between the ethylene glycol units and the cyclohexanedimethanol units (CHDM) ranging from 0/100 mol/mol to 20/80 mol/mol, said textile elementary monofilament having a melting point Tm of greater than 240° C., preferentially greater than or equal to 245° C., a tenacity of greater than or equal to 2.5 cN/mol, preferentially greater than or equal to 3 cN/tex, and an elongation at break of greater than or equal to 10%.

The polyester of the textile elementary monofilament according to the invention may or may not comprise ethylene glycol units. In the case where the polyester does not comprise ethylene glycol units, it is a poly(1,4-cyclohexanedimethylene 2,5-furandicarboxylate), denoted PCF. In the case where the polyester comprises ethylene glycol units, it is a poly(ethylene-co-1,4-cyclohexanedimethylene 2,5-furandicarboxylate), denoted PECF, “co” meaning copolymer.

The furan ring preferentially represents at least 25% by weight of the polyester of the textile elementary monofilament according to the invention.

The weight-average molar mass of the polyester of the textile elementary monofilament according to the invention, measured after the polyester has been granulated in the manner described herein, is preferentially greater than 45 000 g/mol in PMMA equivalent, very preferentially greater than 55 000 g/mol.

The polyester of the textile elementary monofilament according to the invention preferentially has an intrinsic viscosity, measured after the polyester has been granulated in the manner described herein, of greater than 0.7 dL/g, very preferentially greater than 0.8 dL/g.

The polyester of the textile elementary monofilament according to the invention preferentially has a dispersity, measured after the polyester has been granulated in the manner described herein, denoted Ð and representing the ratio of the weight-average molar mass to the number-average molar mass (Ð=Mw/Mn), of less than 2.5, preferably less than 2.0.

The enthalpy of fusion of the polyester according to the invention is preferentially greater than 40 J/g.

In accordance with the invention, the mole ratio between ethylene glycol units and the cyclohexanedimethanol units in the polyester ranges from 0/100 mol/mol to 20/80 mol/mol. Such a ratio, combined with the other characteristics of the polyester, allows particularly advantageous thermomechanical properties to be obtained for the monofilament, such as melting point, tenacity and elongation at break. Preferably, the polyester is a PECF in which the mole ratio between the ethylene glycol units and the cyclohexanedimethanol units ranges from 4/96 mol/mol to 15/85 mol/mol.

Preferably, the textile elementary monofilament has a shrinkage of less than 14%, preferentially less than 12%, lower than that of PEF filaments in the prior art, which is generally of the order of 15% to 30% before any thermal setting step.

The term “elementary monofilament” refers to an element having a length at least 10 times greater than the greatest dimension of its cross section, irrespective of the shape of said cross section: circular, elliptical, oblong, polygonal, notably rectangular or square or oval. In the case of a rectangular cross section, the monofilament has the shape of a band.

The textile elementary monofilament may optionally be coated with one or more layers of a coating based on a non-metallic adhesive composition. This textile elementary monofilament is obtained, for example, by melt spinning, solution spinning or gel spinning. Each textile elementary monofilament has a substantially circular cross-section with a diameter ranging, for example, from 2 μm to 100 μm.

A textile yarn element may be an assembly of several textile elementary monofilaments as defined above, also called a strand. A strand preferably comprises more than 10 textile elementary monofilaments, preferably more than 100 textile elementary monofilaments and more preferentially more than 500 textile elementary monofilaments.

A textile yarn element may also be an assembly of several strands as defined above. This assembly may be made by a twisting step or a succession of twisting steps. This assembly may be composed solely of the filamentary elements of the invention or partially composed of these filaments thus constituting a hybrid assembly.

In one embodiment, the layer based on a non-metallic adhesive composition is formed by a layer of an adhesion primer, allowing improved adhesion of the yarn element, for example to an elastomeric matrix. Such adhesion primers are those commonly used by a person skilled in the art for the pre-sizing of certain textile fibres (notably polyester fibres, for example PET, aramid fibres, aramid/nylon fibres). For example, an epoxy-based primer, notably a polyglycerol polyglycidyl ether-based primer, may be used. A blocked isocyanate-based primer may also be used.

In another embodiment, the layer based on a non-metallic adhesive composition is formed by a layer based on a resin and a latex of elastomer(s). Mention may be made of RFL (Resorcinol-Formaldehyde-Latex) type adhesive compositions, but also adhesive compositions such as those described in WO 2015/118041.

In yet another embodiment, the yarn element may be coated with a layer of an adhesion primer, this layer of adhesion primer itself being coated with a layer based on a resin and a latex of elastomer(s).

### Fabric

The invention also relates to a fabric comprising at least one textile elementary monofilament according to the invention.

Within the fabric, the textile elementary monofilament is preferentially used in the form of a yarn comprising one or more textile elementary monofilaments according to the invention.

As used herein, the term “fabric” means a cloth consisting of a plurality of yarns assembled by weaving, knitting, bonding or any other means known to those skilled in the art.

### Process According to the Invention for Synthesizing a Polyester Transesterification Step

The process according to the invention comprises a step of transesterification of a composition comprising a compound of furandicarboxylate type, denoted RFC, of general formula (II):

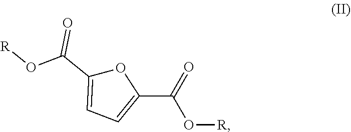

in which R represents an alkyl group comprising from 1 to 3 carbon atoms or a hydrogen atom, the composition also comprising at least one glycol compound chosen from 1,4-cyclohexanedimethanol and the mixture of 1,4-cyclohexanedimethanol and ethylene glycol, this transesterification step being performed at a temperature increasing with a ramp of at least 1° C./min in the range from 180° C. to 280° C., with a glycol compound/RFC mole ratio ranging from 1.1 to 2, preferentially ranging from 1.1 to 1.2, in the presence of a Lewis acid catalyst.

The term “transesterification” is used herein to mean both transesterification when R represents an alkyl group comprising from 1 to 3 carbon atoms, and esterification when R represents a hydrogen atom.

The transesterification step allows oligomers of general formula (I) to be produced, these oligomers being 1,4-cyclohexanedimethylene 2,5-furandicarboxylate oligomers when the composition does not comprise ethylene glycol (thus m=0), or ethylene-co-1,4-cyclohexanedimethylene 2,5-furandicarboxylate oligomers when the composition comprises ethylene glycol.

The operating conditions for this step have a decisive influence on the structure of the polyester obtained. In the composition used in this step, the glycol compound/RFC mole ratio ranges from 1.1 to 2, preferentially from 1.1 to 1.2.

Preferably, R independently represents an alkyl group comprising from 1 to 2 carbon atoms. The compound of general formula (II) then corresponds to dimethyl 2,5-furandicarboxylate, or diethyl 2,5-furandicarboxylate. The use of such a compound allows the dispersity D of the polyester obtained to be significantly reduced.

The transesterification step is performed for a time ranging preferentially from 1 to 5 h, preferably from 1 to 3 h.

In accordance with the invention, the transesterification step is performed at a temperature continuously increasing in the range from 180° C. to 280° C. The term “continuously increasing in the range from 180° C. to at least 280° C.” means that the transesterification step is performed at a temperature in the range from 180° C. to 280° C., the operating temperature increasing during the transesterification step, without reducing. The use of an increasing temperature profile allows any premature crystallization in the transesterification step to be avoided, which would be detrimental to the final product.

In a preferred arrangement, the temperature increases continuously in the range from 180° C. to 280° C. with a ramp of less than or equal to +5° C./min. When the highest temperature is reached, a plateau may be maintained until the degree of transesterification is greater than 80%.

Preferably, the time between the lowest and highest temperature of the transesterification step when the temperature increases continuously is at least equal to 30 min, preferentially at least equal to 45 min.

The transesterification step is preferentially performed at a pressure ranging from 1.5 to 8 bar. Preferably, the step is performed under an inert atmosphere. Operation at a pressure preferentially ranging from 1500 to 8000 mbar allows the transesterification step to be performed in the liquid phase while at the same time removing reaction products such as alcohol (if R is other than H) or water (if R is a hydrogen atom).

The transesterification step is performed in the presence of a Lewis acid catalyst. Preferably, the Lewis acid catalyst is chosen from hafnium acetylacetonate, zirconium acetylacetonate, titanium tetraisopropoxide (TIS) and titanium tetrabutoxide (TTB). Preferably, the Lewis acid catalyst is titanium tetrabutoxide (TTB).

The transesterification step is performed with a catalyst content ranging from 100 to 1000 ppm, preferentially from 150 to 500 ppm, and very preferentially from 200 to 450 ppm.

These operating conditions, with a temperature increasing stepwise over the range mentioned and in the presence of a Lewis acid catalyst, in particular a catalyst such as titanium tetrabutoxide (TTB), allow a degree of transesterification of greater than 80%, or even greater than 90%, to be obtained, an amount of ester functions located at the end of the chain of less than 100 meq/kg, preferably less than 80 meq/kg and preferably less than 30 meq/kg at the end of transesterification for the polyester prepolymer obtained, while at the same time avoiding premature crystallization of certain oligomers. The degree of transesterification is determined by dividing the mass of alcohol (or water when R═H) resulting from the transesterification step by the theoretical mass of alcohol (or water when R═H) produced assuming that all the ester functions (or acid functions when R═H) of the RFC compound have reacted.

### Polycondensation Step

The process according to the invention comprises a melt polycondensation step performed at a temperature of greater than or equal to 260° C. and a pressure of less than 100 mbar so as to obtain a polyester of general formula (I). On conclusion of this step, the sum m+n is preferentially between 25 and 200.

On conclusion of the transesterification step, the pressure is gradually lowered for a period of between 60 and 120 min, preferentially between 80 and 100 min, to reach the operating pressure of the polycondensation step. When the pressure is below 400 mbar, preferably below 300 mbar and very preferably below 200 mbar, the temperature of the reaction medium is increased until the initial operating temperature of the polycondensation step is reached. The temperature rise to the initial operating temperature of the polycondensation step takes place over a period ranging from 15 to 45 minutes.

The use of a low operating pressure, and notably the depressurization phase, allows the ethylene glycol and cyclohexanedimethanol present in the reaction system to be gradually removed and the molar mass of the polymer to be increased. Preferably, the polycondensation step is performed at a temperature of greater than or equal to 270° C., preferably greater than or equal to 280° C. Preferably, the polycondensation step is performed at a pressure of less than 50 mbar, preferably as low as possible, for example preferentially less than 1 mbar.

The polycondensation step is performed for a time ranging preferentially from 10 min to 5 h, preferably from 10 min to 2 h.

The polycondensation step is performed with a catalyst content ranging from 100 to 1000 ppm, preferentially from 150 to 500 ppm, and very preferentially from 200 to 450 ppm. The catalyst is generally added to the reaction system before the transesterification step. If necessary, the catalyst used in the polycondensation step may be topped up with a catalyst identical to or different from that used in the transesterification step.

The polyester obtained on conclusion of this step, called polycondensate, may then be formed, either into granules, into a yarn or into a film. The yarn may be formed using a spinning system, as known to those skilled in the art, so as to obtain a yarn that can be used as such, or used as an assembly of yarns. The yarn may be formed, for example, by passing it through a series of temperature-controlled spools allowing the yarn to be drawn to the desired diameter. Forming into a film may be done by passing the polycondensate over a series of cooled rollers so as to form a film.

Preferably, the polycondensate is cooled rapidly by placing in contact with water and cut into granules. This rapid placing in contact limits the agglomeration of the granules. This granulation step is performed so as to form granules that are substantially homogeneous in size, so as to facilitate the subsequent operations.

In this preferred arrangement, the granules are then dried at a temperature ranging from 80° C. to 100° C. at or below atmospheric pressure in an inert atmosphere, for example a nitrogen atmosphere.

The polyester obtained on conclusion of the polycondensation step is partially crystallized.

The polyester obtained on conclusion of the polycondensation step has an intrinsic viscosity of greater than or equal to 0.50 dL/g. This intrinsic viscosity is linked to the molar mass of the polyester, and is proportionately greater the higher the molar mass of the polyester. Thus, the weight-average molar mass of the polyester obtained on conclusion of this step, expressed in PMMA equivalent, is preferentially greater than 35 000 g/mol. Preferably, the intrinsic viscosity of the polyester is greater than or equal to 0.55 dL/g.

### Crystallization Step

Following the forming of the polyester into granules, a crystallization step may be performed, when the composition used in the transesterification step does not comprise ethylene glycol, at a temperature ranging from 120° C. to the melting point of the polyester, preferentially ranging from 130° C. to 150° C. and lasting from 15 min to 2 h, and can be performed, when the composition used in the transesterification step comprises ethylene glycol, at a temperature ranging from 220° C. to the melting point of the polyester, preferably ranging from 220° C. to 230° C. and lasting from 10 min to 2 h.

### Solid State Post-Condensation Step

In order to increase the weight-average molar mass of the polyester obtained and its melting point, it is advantageous to perform a solid-state post-condensation step following the crystallization step. This step is performed by heating the polyester to a temperature close to and below its melting point under a flow of inert gas, preferentially under a flow of nitrogen.

Thus, the solid-phase post-condensation step is performed at a temperature increasing in the range 200° C. to 260° C. and for a time ranging from 1 to 60 h. Preferentially, the solid-phase post-condensation step is performed at a temperature increasing in the range from 210° C. to 260° C., preferentially in the range from 220° C. to 250° C. for a time ranging from 24 h to 72 h, preferentially from 24 h to 60 h. Preferably, the temperature of the solid-phase post-condensation step is increased in steps in the range from 2 to 10° C.

By performing this step with a temperature increasing in the range from 210° C. to 260° C., preferentially in the range from 220° C. to 250° C., preferably by increasing this temperature in steps in the range from 2 to 10° C., preferentially from 3 to 5° C., the increase in the molar mass and melting point of the polyester obtained is maximized. Thus, the polyester obtained has a melting point preferably above 240° C. In addition, and surprisingly, the melting zone, i.e. the temperature range visible on the thermogram obtained by DSC using the method described later in the present document in which melting is observed, is significantly reduced relative to the polyesters obtained via the processes of the prior art.

On conclusion of the solid-state post-condensation step, the intrinsic viscosity of the polyester is increased, preferably greater than or equal to 0.7 dL/g, and more preferably greater than or equal to 0.8 dL/g. Thus, the weight-average molar mass of the polyester is preferentially greater than 45 000 g/mol in PMMA equivalent.

In the preferred case where R is other than a hydrogen atom in formula (II), the polyester has a lower dispersity D, preferentially less than 2.5.

### Forming Step

The polyester obtained on conclusion of this post-condensation step may then be formed, in particular into a yarn.

The forming into yarn is performed via a polyester spinning step. The polyester is placed in an extrusion screw at a temperature above the melting point of the polyester, adjusted so that the pressure at the die inlet is between 3.3 and 10.0 MPa. On leaving the die, the flowing polyester is cooled in a vertical chamber and received on a pair of room temperature cups rotating at a circumferential speed of 100 to 5000 m/min, preferentially 300 to 3000 m/min, very preferentially 300 to 500 m/min, the circumferential speed being understood as the distance covered by a point on the outer surface of the cup in contact with the yarn per unit of time. A drawing step is then performed in line on a series of drawing cups, each drawing cup being at a temperature ranging from 105° C. to 145° C., the temperature of the last drawing cup ranging from 40 to 80° C., the draw ratio, measuring, in a manner known to those skilled in the art, the ratio of speeds between the last cup before winding and the first receiving cup, ranging from strictly more than 3 to 6, preferentially from 3.1 to 5, very preferentially from 3.5 to 5. Preferentially, the final winding speed is between 500 and 5000 m/min, preferentially between 1000 and 3000 m/min, this speed corresponding to the speed of the monofilament leaving the last cup. The size of the unit filaments may range from 1 to 25 dpf (denier per filament), one denier corresponding to 1 g per 9000 m of filament.

A draw ratio strictly greater than 3, preferentially greater than or equal to 3.1 and very preferentially greater than 3.5 allows a monofilament to be obtained with particularly advantageous mechanical characteristics, and notably tenacity.

On conclusion of the forming step, the yarn obtained has a tenacity of greater than or equal to 2.5 cN/tex, preferentially greater than or equal to 3.0 cN/tex, and an elongation at break of greater than or equal to 10%, measured in accordance with the standard ASTM D885-03.

### Measurement Methods

### Shrinkage

The shrinkage measurement is performed by placing the textile elementary monofilament or, where appropriate, an assembly of textile elementary monofilaments in the form of a multifilament yarn, under a tension of 0.5 cN/tex, then measuring the initial length L₀ of the filament at room temperature, and the length L₁ after two minutes spent at 180° C. in a preheated chamber. The shrinkage is calculated according to (L₀-L₁)/L₀, expressed in %. This measurement makes it possible to define the dimensional stability of a textile. For many uses, it is important that the textile does not deform when subjected to temperature changes (in use or during washing operations). In this particular case, the Applicant found that the yarn obtained inherently had very low shrinkage, less than 12% or even less than 10%, even before an additional thermal setting operation.

### Amount of Ester Functions at the End of the Chain

The amount of ester functions located at the end of the chain is measured by NMR spectroscopy.

This is performed either in HFIP-d (deuterated hexafluoro-2-propanol) so as to see the alcohol chain ends, or in a 25/75 vol./vol. TFA-d/CDCl₃ mixture to study the ester chain ends, the decarboxylated ends and to determine the DEG content, where TFA-d represents deuterated trifluoroacetic acid and CDCl₃ represents deuterated chloroform.

The molar percentage of chain ends per unit is calculated as follows:

$$ester chain ends per repeating unit = \frac{\frac{\int ester CH3 signal}{3}}{\frac{\int furan signal}{2}} * 100$$

The decarboxylated signals are not observable in the process according to the invention and are thus ignored.

### Method for Measuring the Content of DEG Units

The amount of DEG units is measured by NMR spectroscopy.

A value of 200 is given to the furan signal, integrated between 7.28 and 7.37 ppm (number of furan protons per 100 repeating units), then the following formula is applied:

$$molar \% DEG relative to the furan = \frac{\frac{\int alpha ether CH2 signal}{4}}{\frac{\int furan signal}{2}} * 100$$

Thus, the % DEG is expressed per 100 repeating units.

### Glass Transition Temperature, Melting Point and Crystallization Temperature

The glass transition temperature Tg, melting point Tm and crystallization temperature are measured by differential scanning calorimetry (DSC) in accordance with the standard ISO 11357-2 of March 2020 for the glass transition temperature, and ISO 11357-3 of March 2018 for the melting point and crystallization enthalpy, with the recommended temperature ramp of 10 K/min being applied.

The Tg, the cold and hot crystallization temperatures, the degree of crystallinity and the Tm were measured by DSC, using the following cycle:

A rise from 30° C. to 280° C., a 2 min isotherm at 280° C. followed by a temperature decrease from 280° C. to 30° C., then a 2 min isotherm at 30° C., and finally a final rise from 30° C. to 280° C. The speed was always set at 10° C./min, both up and down.

### Intrinsic Viscosity (IV)

The intrinsic viscosity (IV) is measured in solution, in a mixture of phenol/ortho-dichlorobenzene.

The polymers are dissolved at a concentration C equal to 5 g/L in an equal-mass mixture of phenol/ortho-dichlorobenzene. In order to promote dissolution, the mixture of solvent and granules is placed for a few minutes at 120° C. with vigorous stirring. Finally, before being introduced into the Ubbelohde-type capillary viscometer, the solution is filtered using 0.45 μm PTFE filters.

The intrinsic viscosity (IV) is measured at 25° C. and calculated using the following formulae:

$$η ( intrinisic ) = \frac{\sqrt{2}}{C} \times \sqrt{( η ( specific ) - ln ( η ( relative ) )}$$

With C being the concentration of the solution in g per 100 mL, and the specific and relative viscosities calculable via the following formulae:

$$η ( specific ) = ( η \cdot η 0 ) / η 0$$

$$η ( relative ) = η / η 0$$

where η0 is the viscosity of the solvent alone and η is the viscosity of the macromolecular solution.

### Measuring the Crystallinity of the Polymer

The crystallinity of the polymer is determined via the formula: ((ΔHm sample-ΔHc sample)/ΔHm°)*100 with ΔHm sample, the enthalpy of fusion in the first rise, ΔHc sample, the enthalpy of cold crystallization in the first rise, and ΔHm° the standard enthalpy of fusion of poly(cyclohexane dimethylene furanoate), noted PCF, and equal to 137 J/g according to the literature.

### Size Exclusion Chromatography (SEC) Measurements

The SEC analyses were performed in hexafluoroisopropanol (HFIP). The solutions were prepared at a concentration of 1 mg/mL. Prior to analysis, the samples were filtered using 0.45 μm PTFE filters.

The sample to be analysed is introduced into APC XT columns using an automatic sample injector (Sample Manager pFTN) and a Waters Acquity Advanced Polymer Chromatography (APC) pump. An autosampler (Sample Manager pFTN) allows the next sample to be taken.

SEC method for expressing Mn in PMMA equivalent:

The molar masses are evaluated using a differential refractive index detector (Waters RI detector) allowing the relative molar mass of our polymers to be determined from a calibration curve constructed from PMMA standards at 35° C., the eluent used being hexafluoroisopropanol (HFIP).

### Example 1

A transesterification step is fed with a composition comprising dimethyl furandicarboxylate (DMF) and 1,4-cyclohexanedimethanol (CHMD) with a glycol/DMF mole ratio equal to 1.15. This composition is placed in the presence of 200 ppm of titanium tetrabutoxide (TTB) catalyst.

The transesterification step is performed at 1.7 bar with a temperature ranging from 180° C. to 260° C. with a temperature ramp of +4° C./min for 20 min, the highest temperature being maintained once reached until the degree of transesterification is 90%.

On conclusion of this step, a prepolymer is obtained in which the presence of the DEG unit is not detectable. The degree of transesterification is 90%.

The pressure of the reaction medium is then gradually reduced while maintaining the temperature at 260° C. When the pressure reaches a value of P<200 mbar, the temperature is raised to 280° C. over 20 min. After 1 hour 30 mins of vacuum lowering, the pressure is less than 1 mbar and the temperature is maintained at 280° C. for 90 minutes.

On conclusion of the polycondensation step, the polycondensate is rapidly cooled by placing in contact with water and is cut into granules.

The PCF polyester obtained on conclusion of the polycondensation step has the following characteristics:
Intrinsic viscosity (IV): 0.57 dL/g
Integrated EG/CHDM mole ratio: 0/100 mol/mol
Amount of ester functions at the end of the chain: 11 meq/kg
Number-average molar mass Mn (PMMA equivalent): 21 100 g/mol
Weight-average molar mass Mw (PMMA equivalent): 40 090 g/mol
Dispersity (Ð): 1.9
Melting point: 271° C.

The granules obtained are then dried for 5 h at 100° C. and then treated in a crystallization step in which they are maintained at a temperature of 130° C. for 30 min.

On conclusion of the crystallization, a solid-state post-condensation step is performed by maintaining the granules at a temperature of 225° C. for 25 h under a flow of nitrogen.

The polyester obtained on conclusion of this step has the following characteristics:
Intrinsic viscosity (IV): 0.81 dL/g
Glass transition temperature: 90.6° C.
Melting point: 258.4° C.
Heat of fusion: 68.3 J/g
Weight-average molar mass Mw (PMMA equivalent): 60 000 g/mol
Number-average molar mass Mn (PMMA equivalent): 27 200 g/mol
Dispersity: 2.2

### Example 2

A transesterification step is fed with a composition comprising dimethyl furandicarboxylate (DMF), ethylene glycol (EG) and 1,4-cyclohexanedimethanol (CHMD) with a glycol/DMF mole ratio equal to 1.2 and an EG/CHDM mole ratio equal to 15/85 mol/mol. This composition is placed in the presence of 200 ppm of titanium tetrabutoxide (TTB) catalyst.

The transesterification step is performed at 6.8 bar with a temperature ranging from 180° C. to 260° C. with a temperature ramp of +4° C./min for 20 min, the highest temperature being maintained once reached until the degree of transesterification is 90%.

On conclusion of this step, a prepolymer is obtained in which the presence of the DEG unit is not detectable. The degree of transesterification is greater than 90%.

The pressure of the reaction medium is then gradually reduced while maintaining the temperature at 260° C. When the pressure reaches a value of P<200 mbar, the temperature is raised to 280° C. over 20 min. After 1 hour 30 mins of vacuum lowering, the pressure is less than 1 mbar and the temperature is maintained at 280° C. for 30 minutes.

On conclusion of the polycondensation step, the polycondensate is rapidly cooled by placing in contact with water and is cut into granules.

The PECF polyester obtained on conclusion of the polycondensation step has the following characteristics:
Intrinsic viscosity (IV): 0.62 dL/g
Integrated EG/CHDM mole ratio: 4/96 mol/mol
Amount of ester functions at the end of the chain: 8 meq/kg
Number-average molar mass Mn (PMMA equivalent): 22 000 g/mol
Weight-average molar mass Mw (PMMA equivalent): 39 600 g/mol
Dispersity (Ð): 1.8
Glass transition temperature: 81.4° C.
Cold crystallization temperature: 130° C.
Heat of crystallization: 30 J/g
Degree of crystallinity: 14%
Melting point: 265° C.
Heat of fusion: 49 J/g

The granules obtained are then dried for 5 h at 100° C. and then treated in a crystallization step in which they are maintained at a temperature of 220° C. for 20 min.

On conclusion of the crystallization, a solid-state post-condensation step is performed by maintaining the granules at a temperature of 235° C. for 20 h under a flow of nitrogen.

The polyester obtained on conclusion of this step has the following characteristics:
Intrinsic viscosity (IV): 0.83 dL/g
Glass transition temperature: 89° C.
Melting point: 257° C. and 265° C., indicating that part of the population obtained on conclusion of the polycondensation step has not disappeared.
Number-average molar mass Mn (PMMA equivalent): 30 000 g/mol
Weight-average molar mass Mw (PMMA equivalent): 63 000 g/mol
Dispersity: 2.1
Heat of fusion: 65 J/g

### Example 3

A transesterification step is fed with a composition comprising dimethyl furandicarboxylate (DMF), ethylene glycol (EG) and 1,4-cyclohexanedimethanol (CHMD) with a glycol/DMF mole ratio equal to 1.2 and an EG/CHDM mole ratio equal to 20/80 mol/mol. This composition is placed in the presence of 200 ppm of titanium tetrabutoxide (TTB) catalyst.

The transesterification step is performed at 6.8 bar with a temperature ranging from 180° C. to 260° C. with a temperature ramp of +4° C./min for 20 min, the highest temperature being maintained once reached until the degree of transesterification is 90%.

On conclusion of this step, a prepolymer is obtained in which the presence of the DEG unit is not detectable. The degree of transesterification is greater than 90%.

The pressure of the reaction medium is then gradually reduced while maintaining the temperature at 260° C. When the pressure reaches a value of P<200 mbar, the temperature is raised to 280° C. over 20 min. After 1 hour 30 mins of vacuum lowering, the pressure is less than 1 mbar and the temperature is maintained at 280° C. for 10 minutes.

On conclusion of the polycondensation step, the polycondensate is rapidly cooled by placing in contact with water and is cut into granules.

The PECF polyester obtained on conclusion of the polycondensation step has the following characteristics:
Intrinsic viscosity (IV): 0.61 dL/g
Integrated EG/CHDM mole ratio: 8/92 mol/mol
Amount of ester functions at the end of the chain: 17 meq/kg
Number-average molar mass Mn (PMMA equivalent): 22 500 g/mol
Weight-average molar mass Mw (PMMA equivalent): 40 500 g/mol
Dispersity (Ð): 1.8
Glass transition temperature: 78° C.
Melting point: 258° C.

The granules obtained are then dried for 5 h at 100° C. and then treated in a crystallization step in which they are maintained at a temperature of 220° C. for 20 min.

On conclusion of the crystallization, a solid-state post-condensation step is performed by maintaining the granules at a temperature of 232° C. for 14 h under a flow of nitrogen.

The polyester obtained on conclusion of this step has the following characteristics:
Intrinsic viscosity (IV): 0.83 dL/g
Glass transition temperature: 87° C.
Melting point: 249° C. and 258° C., indicating that part of the population obtained on conclusion of the polycondensation step has not disappeared.
Heat of fusion: 57.5 J/g
Number-average molar mass Mn: 27 700 g/mol
Weight-average molar mass Mw: 55 400 g/mol
Dispersity: 2.2

### Example 4

A transesterification step is fed with a composition comprising dimethyl furandicarboxylate (DMF), ethylene glycol (EG) and 1,4-cyclohexanedimethanol (CHMD) with a glycol/DMF mole ratio equal to 1.2 and an EG/CHDM mole ratio equal to 25/75 mol/mol. This composition is placed in the presence of 200 ppm of titanium tetrabutoxide (TTB) catalyst.

The transesterification step is performed at 6.8 bar with a temperature ranging from 180° C. to 260° C. with a temperature ramp of +4° C./min for 20 min, the highest temperature being maintained once reached until the degree of transesterification is 90%.

On conclusion of this step, a prepolymer is obtained in which the presence of the DEG unit is not detectable. The degree of transesterification is greater than 90%.

The pressure of the reaction medium is then gradually reduced while maintaining the temperature at 260° C. When the pressure reaches a value of P<200 mbar, the temperature is raised to 280° C. over 20 min. After 1 hour 30 mins of vacuum lowering, the polymer is cast directly.

On conclusion of the polycondensation step, the polycondensate is rapidly cooled by placing in contact with water and is cut into granules.

The PECF polyester obtained on conclusion of the polycondensation step has the following characteristics:
Intrinsic viscosity (IV): 0.61 dL/g
Amount of ester functions at the end of the chain: 20 meq/kg
Integrated EG/CHDM mole ratio: 14/86 mol/mol
Number-average molar mass Mn (PMMA equivalent): 22 300 g/mol
Weight-average molar mass Mw (PMMA equivalent): 42 370 g/mol
Dispersity (Ð): 1.9
Glass transition temperature: 75° C.
Melting point: 248° C.

The granules obtained are then dried for 5 h at 100° C. and then treated in a crystallization step in which they are maintained at a temperature of 220° C. for 20 min.

On conclusion of the crystallization, a solid-state post-condensation step is performed by maintaining the granules at a temperature of 225° C. for 14 h under a flow of nitrogen.

The polyester obtained on conclusion of this step has the following characteristics:
Intrinsic viscosity (IV): 0.83 dL/g
Glass transition temperature: 84° C.
Melting point: 248° C.
Heat of fusion: 53.9 J/g
Number-average molar mass Mn (PMMA equivalent): 27 600 g/mol
Weight-average molar mass Mw (PMMA equivalent): 58 000 g/mol
Dispersity: 2.1

### Example 5—Spinning of the Polyesters Obtained in Examples 1 to 4

The spinning tests were performed using the four materials described in the preceding examples.

The polymers produced as described in Examples 1, 2, 3 and 4 above are formed by in-line extrusion-spinning in the form of a yarn (monofilament) with the following process characteristics:
a die temperature of 275° C. to 280° C.
a speed of the first pair of receiving cups ranging between 300 and 600 m per minute
a winding speed after drawing of between 1500 and 1800 m/min
the ratio between these two speeds resulting in a draw ratio ranging from 3 to 5
cup temperatures ranging from 105 to 145° C. for the first three pairs and from 45° C. to 75° C. for the fourth pair.

The results obtained under different conditions are summarized in Table 1 below. Examples 11, 12, 13 are performed using the polymer made as described in Example 1, Examples 21, 22, 23 using the polymer described in Example 2, Examples 31, 32, 33, 34 and 35 using the polymer described in Example 3 and Examples 41, 42, 43 and 44 using the polymer described in Example 4.

TABLE 1

| | T | Cup pair | Cup pair | | T | T | T | T |
|---|---|---|---|---|---|---|---|---|
| | spinning | speed 1 | speed 5 | | pair 2 | pair 3 | pair 4 | pair 5 |
| Example | (° C.) | (m/min) | (m/min) | drawing | (° C.) | (° C.) | (° C.) | (° C.) |
| 11 comparative | 280 | 500 | 1500 | 3 | 105 | 105 | 105 | 45 |
| 12 | 275 | 450 | 1800 | 4 | 120 | 120 | 105 | 45 |
| 13 | 275 | 419 | 1800 | 4.3 | 125 | 125 | 105 | 45 |
| 21 Comparative | 280 | 500 | 1500 | 3 | 125 | 125 | 105 | 45 |
| 22 | 280 | 375 | 1500 | 4 | 125 | 125 | 105 | 45 |
| 23 | 280 | 375 | 1500 | 4 | 125 | 145 | 105 | 75 |
| 31 Comparative | 280 | 500 | 1500 | 3 | 125 | 125 | 105 | 45 |
| 32 | 280 | 375 | 1500 | 4 | 125 | 125 | 105 | 45 |
| 33 | 280 | 333 | 1500 | 4.5 | 125 | 125 | 105 | 45 |
| 34 | 280 | 333 | 1500 | 4.5 | 125 | 125 | 145 | 45 |
| 35 | 280 | 333 | 1500 | 4.5 | 125 | 145 | 145 | 75 |
| 41 Comparative | 280 | 500 | 1500 | 3 | 125 | 125 | 105 | 45 |
| 42 | 280 | 375 | 1500 | 4 | 125 | 125 | 105 | 45 |
| 43 | 280 | 316 | 1500 | 4.75 | 125 | 125 | 105 | 45 |
| 44 | 280 | 300 | 1500 | 5 | 125 | 145 | 105 | 45 |

After spinning under the conditions described above, the strands are characterized. The results are presented in Table 2 below.

TABLE 2

| | Tenacity | Elongation at | Shrinkage at |
|---|---|---|---|
| Example | cN/dtex | break (%) | 180° C., 2′ (%) |
| 11 comparative | 1.8 | 36 | 12 |
| 12 | 2.7 | 15 | 9 |
| 13 | 2.8 | 16 | 9 |
| 21 comparative | 2.0 | 46 | 0 |
| 22 | 2.8 | 21 | 10 |
| 23 | 2.9 | 20 | 3 |
| 31 comparative | 1.9 | 57 | 7 |
| 32 | 2.8 | 25 | 10 |
| 33 | 3.1 | 16 | 12 |
| 34 | 3.2 | 17 | 11 |
| 35 | 3.2 | 17 | 10 |
| 41 comparative | 1.7 | 70 | −9 |
| 42 | 2.5 | 27 | 9 |
| 43 | 3 | 16 | 11 |
| 44 | 3.3 | 17 | 11 |

It can be seen that, for the tests performed using the four examples of polymer with EG/CHDM diol mole ratios of 0/100, 4/96, 8/92 and 14/86, it is possible to obtain multistrands with a tenacity of greater than or equal to 2.5 cN/dtex if a draw ratio of greater than 3 is applied. These characteristics allow a multifilament to be obtained with a high melting point (>240° C.), comprising a biosourceable furan monomer which can be used in the textile industry and which has the advantage of good mechanical strength, high elongation and low thermal shrinkage.

1.-15. (canceled)

16. A textile elementary monofilament consisting of a polyester of formula (I) 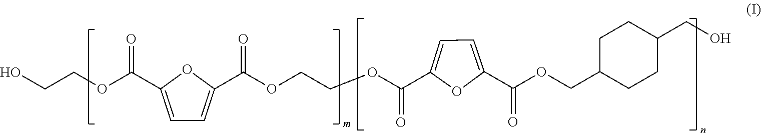
wherein m represents a total number of ethylene glycol furandicarboxylate units and n represents a total number of cyclohexanedimethanol furandicarboxylate units, with n being non-zero and m+n≥25,
wherein a mole ratio between ethylene glycol units denoted EG and cyclohexanedimethanol units denoted CHDM ranges from 0/100 mol/mol to 20/80 mol/mol, and
wherein the textile elementary monofilament has a melting point Tm of greater than or equal to 240° C., a tenacity of greater than or equal to 2.5 cN/tex, and an elongation at break of greater than or equal to 10%.

17. The textile elementary monofilament according to claim 16, wherein the polyester has a weight-average molar mass of greater than 45 000 g/mol in PMMA equivalent.

18. The textile elementary monofilament according to claim 16, wherein the polyester has an intrinsic viscosity of greater than 0.7 dL/g.

19. The textile elementary monofilament according to claim 16, wherein the tenacity is greater than or equal to 3 cN/tex, and the elongation at break is greater than or equal to 15%.

20. The textile elementary monofilament according to claim 16, wherein the textile elementary monofilament has a shrinkage of less than 14%.

21. A fabric comprising at least one textile elementary monofilament according to claim 16.

22. A process for preparing a textile elementary monofilament consisting of a polyester, comprising successively:
a step of transesterification of a composition comprising a compound of furandicarboxylate type, denoted RFC, of general formula (II) 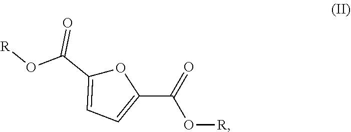
wherein R represents an alkyl group comprising from 1 to 3 carbon atoms or a hydrogen atom,
wherein the composition further comprises at least one glycol compound selected from the group consisting of 1,4-cyclohexanedimethanol and a mixture of 1,4-cyclohexanedimethanol and ethylene glycol, and
wherein transesterification is performed at a temperature increasing with a ramp of at least 1° C./min in a range from 180° C. to 280° C., with a glycol compound/RFC mole ratio ranging from 1.1 to 2 in the presence of a Lewis acid catalyst;
a melt polycondensation step performed at a temperature of greater than or equal to 260° C. and a pressure of less than 100 mbar so as to obtain the polyester, the 1,4-cyclohexanedimethanol being present in the composition of the transesterification step in a content such that a mole ratio between ethylene glycol units and cyclohexanedimethanol units in the polyester on conclusion of the polycondensation step ranges from 0/100 mol/mol to 20/80 mol/mol; and
a step of spinning the polyester so as to obtain the textile elementary monofilament.

23. The process according to claim 22, wherein, in the transesterification step, the temperature rises continuously in the range from 180° C. to 280° C. at a ramp of less than or equal to +5° C./min.

24. The process according to claim 22, wherein the catalyst used in the transesterification step is selected from the group consisting of hafnium acetylacetonate, zirconium acetylacetonate, titanium tetraisopropoxide and titanium tetrabutoxide.

25. The process according to claim 22, wherein the polycondensation step is performed at a temperature of greater than or equal to 270° C.

26. The process according to claim 22, wherein the polycondensation step is performed at a pressure of less than 50 mbar.

27. The process according to claim 22, wherein, following the polycondensation step, a forming step is performed, in which the polyester is rapidly cooled by placing the polyester in contact with water, then cutting the polyester into granules, and then drying the polyester at a temperature ranging from 80° C. to 100° C. at a pressure less than or equal to atmospheric pressure under an inert atmosphere.

28. The process according to claim 27, wherein, following the forming step, a crystallization step is performed, when the composition used in the transesterification step does not comprise ethylene glycol, at a temperature ranging from 120° C. to a melting point of the polyester and for a time ranging from 15 min to 2 h, and performed, when the composition used in the transesterification step comprises ethylene glycol, at a temperature ranging from 220° C. to the melting point of the polyester and for a time ranging from 10 min to 2 h, followed by a solid-phase post-condensation step performed at a temperature increasing in a range from 200° C. to 260° C. and for a time ranging from 1 to 60 h.

29. The process according to claim 28, wherein the solid-phase post-condensation step is performed at a temperature increasing in a range from 210° C. to 260° C. for a time ranging from 24 h to 72 h under a flow of inert gas.

30. The process according to claim 22, wherein the spinning step, performed as a last step of the process, is performed at a temperature above a melting point of the polyester, adjusted so that the pressure at a die inlet is between 3.3 and 10.0 MPa, followed by a drawing step on a series of drawing cups, each drawing cup being at a temperature ranging from 40° C. to 160° C., a draw ratio ranging from 3 to 6.
